(19) United States
(12) Patent Application Publication
(10) Pub. No.: US 2011/0002511 A1
(43) Pub. Date: Jan. 6, 2011

(54) MOLE IDENTIFYING DEVICE, AND PERSONAL AUTHENTICATION DEVICE, METHOD, AND PROGRAM

(76) Inventor: Hitoshi Imaoka, Tokyo (JP)

Correspondence Address: Mr. Jackson Chen, 6535 N. STATE HWY 161, IRVING, TX, 75039, US

(21) Appl. No.: 12/919,061

(22) PCT Filed: Feb. 6, 2009
(86) PCT No.: PCT/JP2009/052023

§ 371 Date: Aug. 24, 2010

(30) Foreign Application Priority Data
Feb. 27, 2008 (JP) 2008-046463

(51) Int. Cl. G06K 9/00

(52) U.S. Cl. 382/118; 382/165

(57) ABSTRACT

A mole identifying method having the following steps: inputting a multispectral image photographed using an imaging device and composed of a plurality of spectra; detecting mole candidates from said multispectral image; and identifying said mole candidates as a true mole or false mole based on the absorption spectra of said detected mole candidates.

### TECHNICAL FIELD

The present invention relates to a mole identifying device, method, and program and particularly to a mole identifying device, method, and program extracting moles from human face images. The present invention further relates to a personal authentication device, method, and program authenticating a person using moles extracted from face images.

### BACKGROUND ART

Face authentication techniques that, with input of a human face image, utilize characteristics of the face image are known. Face authentication using birthmarks on the face or skin such as moles is considered to be an excellent method because birthmarks change little with age. A face authentication technique using moles is described in Non-Patent Literature 1. In the Non-Patent Literature 1, the degree of separation in brightness between the center and periphery of a circular region is obtained and used as a mole possibility. Ten moles are extracted from the face image in the descending order of the mole possibility. Personal authentication is performed based on the degree of similarity in the positions of moles. In the Non-Patent Literature 1, a region having brightness lower in the center than in the periphery and a small dark area is considered to be a mole.

Another face authentication technique is described in Patent Literature 1. In the Patent Literature 1, characteristics of a face to be searched for are specified as search criteria and a face image having the specified characteristics is searched for. In the Patent Literature 1, the search criteria for searching for a face image include moles, eyelids, mustache/beard, eyeglasses, gender, probable age, and skin color. For extracting moles, a region where a given number or more of pixels having a brightness value equal to or lower than a threshold compared with the surrounding region gather is considered to be a mole.

Patent Literature 1: Unexamined Japanese Patent Application KOKAI Publication No. 2006-318375; and

Non-Patent Literature 1 Tomokazu Kawahara, Osamu Yamaguchi, Kazuhiro Fukui, “Personal Authentication using Global Structure composed of small characteristics on a face,” The 5th System Integration Division Academic Lecture Meeting (SI2004), Dec. 17 to 19, 2004, pp. 619-620.

### DISCLOSURE OF INVENTION

In the Patent Literature 1 and Non-Patent Literature 1, low brightness regions in a face image are considered to be moles. Here, a problem is that there is no distinction between moles and other low brightness regions appearing on the face. For example, if a resembling black dot is written on the face with ink, that region has low brightness in a grayscale image and is recognized as a mole. Therefore, if an ill-intentioned imposter wears a fake mole at the same position as of a registered person, it is impossible to find out the fake mole and prevent the impersonation.

The purpose of the present invention is to solve the above problem and provide a mole identifying device, personal authentication device, method, and program capable of distinguishing between true moles and false moles.

The present invention provides a mole identifying method having the following steps: inputting a multispectral image photographed using an imaging device and composed of a plurality of spectra; detecting mole candidates from the multispectral image; and identifying the mole candidates as a true mole or false mole based on the absorption spectra of the detected mole candidates.

The present invention provides a personal authentication method having the following steps: inputting a multispectral image photographed using an imaging device and composed of a plurality of spectra; detecting mole candidates from the multispectral image; identifying the mole candidates as a true mole or false mole based on the absorption spectra of the detected mole candidates and detecting the positions of the moles identified as a true mole; and verifying face images based on the positional relationship between the moles identified as a true mole and the moles detected in registered verification images.

The present invention provides a mole identifying device comprising: an image input unit inputting a multispectral image photographed using an imaging device and composed of a plurality of spectra; and a mole position estimation unit detecting mole candidates from the multispectral image and identifying the mole candidates as a true mole or false mole based on the absorption spectra of the detected mole candidates.

The present invention provides a personal authentication device comprising: an image input unit inputting a multispectral image photographed using an imaging device and composed of a plurality of spectra; a mole position estimation unit detecting mole candidates from the multispectral image, identifying the mole candidates as a true mole or false mole based on the absorption spectra of the detected mole candidates, and detecting the positions of the moles identified as a true mole; and an image verification unit verifying face images based on the positional relationship between the moles identified as a true mole and the moles detected in registered images.

The present invention provides a program allowing a computer to execute procedures for identifying moles contained in a face image wherein the program allows the computer to execute the following procedures: inputting a multispectral image photographed using an imaging device and composed of a plurality of spectra; detecting mole candidates from the multispectral image; and identifying the mole candidates as a true mole or false mole based on the absorption spectra of the detected mole candidates.

The present invention provides a program allowing a computer to execute personal authentication using moles contained in a face image wherein the program allows the computer to execute the following procedures: inputting a multispectral image photographed using an imaging device and composed of a plurality of spectra; detecting mole candidates from the multispectral image; identifying the mole candidates as a true mole or false mole based on the absorption spectra of the detected mole candidate and detecting the positions of the moles identified as a true mole; and verifying face images based on the positional relationship between the moles identified as a true mole and the moles detected in registered images.

The mole identifying device, personal authentication device, method, and program of the present invention can distinguish between true moles and false moles in possible mole regions contained in a face image.

The above and other purposes, characteristics, and benefits of the present invention will be apparent from the explanation given below with reference to the drawings.

### BRIEF DESCRIPTION OF DRAWINGS

FIG. 1 is a block diagram showing a personal authentication device of Embodiment 1 of the present invention;

FIG. 2 is a flowchart showing the authentication operation procedure;

FIG. 3 is a flowchart showing the mole position detection operation procedure;

FIG. 4 is a flowchart showing the verification operation procedure;

FIG. 5 is a flowchart showing the operation procedure of a personal authentication device of Embodiment 2 of the present invention; and

FIG. 6 is a flowchart showing the mole position detection operation procedure in Embodiment 2.

### BEST MODE FOR CARRYING OUT THE INVENTION

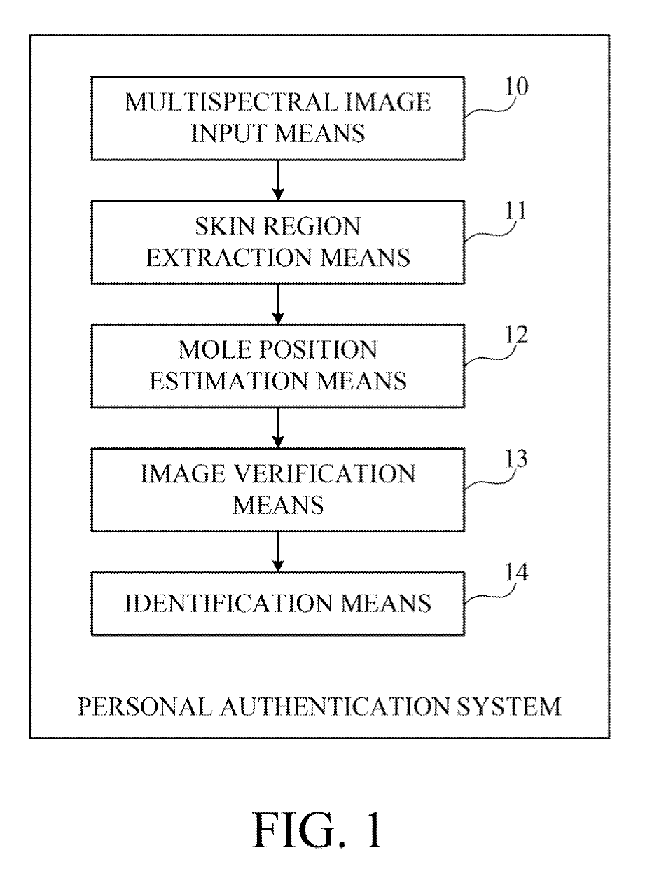

Embodiments of the present invention will be described hereafter with reference to the drawings. FIG. 1 shows a personal authentication device (system) of Embodiment 1 of the present invention. The personal authentication system has a multispectral image input means 10, a skin region extraction means 11, a mole position estimation means 12, an image verification means 13, and an identification means 14. The image input means 10 inputs an image to be used in verification for personal authentication. The image input by the image input means 10 is two or more spectral images (multispectral image) composed of multiple spectra. The skin region extraction means 11 extracts a face skin region excluding the eyes, mouth, and hair region from the multispectral image input by the image input means 10. The above means of the personal authentication system are constituted by one or multiple programs stored in a computer-readable recording medium.

The mole position estimation means 12 extracts moles from the extracted skin region and estimates the mole positions. In doing so, a true mole and a false mole are distinguished based on the average absorption spectrum of each mole. The image verification means 13 verifies the mole positions of the moles detected as a true mole by the mole position estimation means 12 using geometrically-constraining conditions regarding mole position shifts between images used for verification and calculates the degree of similarity between the images. The identification means 14 applies the obtained degree of similarity to threshold processing and determines the identity of the subject.

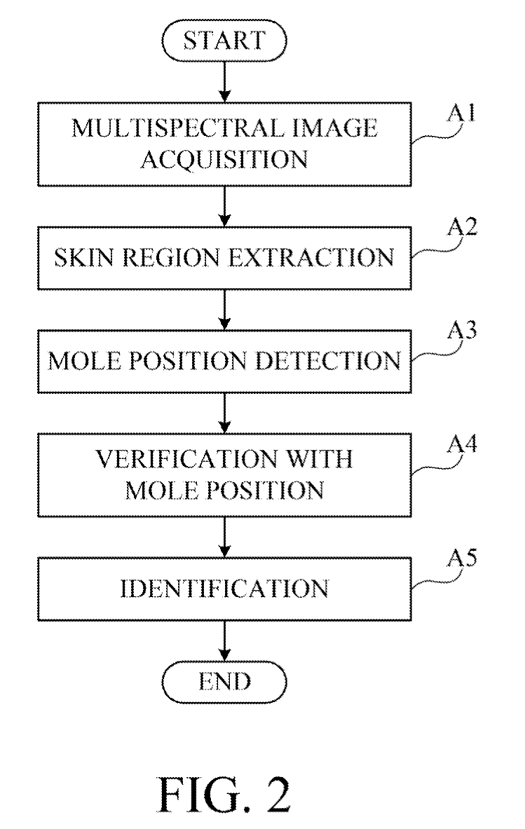

FIG. 2 shows the overall operation procedure. The image input means (unit) 10 captures a face image using a multispectral camera capable of acquiring multiple spectral images at a time and inputs the multispectral image (Step A1). The brightness value of the input multispectral image is represented by I (x, λ) in which x is the pixel position in the face image and λ is a wavelength. Assuming the number of spectra of the multispectral image is Nsp, Nsp face images are obtained in Step A1.

The skin region extraction means 11 extracts a skin region in the face image of each spectral image (Step A2). For extracting a skin region, for example, the face image is blurred to a certain extent using a Gaussian filter. The median value of the brightness values is obtained for each spectrum. The pixels having a square error in brightness within a threshold from the median value are extracted as a skin region. Blurring with a Gaussian filter at the beginning of extracting a skin region allows moles in the skin to be extracted as a skin region. On the other hand, fairly large regions having different brightness distributions such as the eyes, mouth, and lips are excluded from the skin region.

The mole position estimation means 12 detects the mole positions in the skin region extracted in Step A2 for each spectral image (Step A3). In doing so, the mole position estimation means 12 distinguishes between true moles and false moles. Moles including false moles tend to exhibit high levels of light absorption in all spectra compared with regular skin regions and have a low average brightness. Then, first, one grayscale image is generated from multiple spectral images and possible mole regions are extracted from the grayscale image. Then, the average absorption spectra of the extracted possible mole regions in each spectral image are obtained. Subsequently, the average absorption spectra of the moles are compared to distinguish between true moles and false moles.

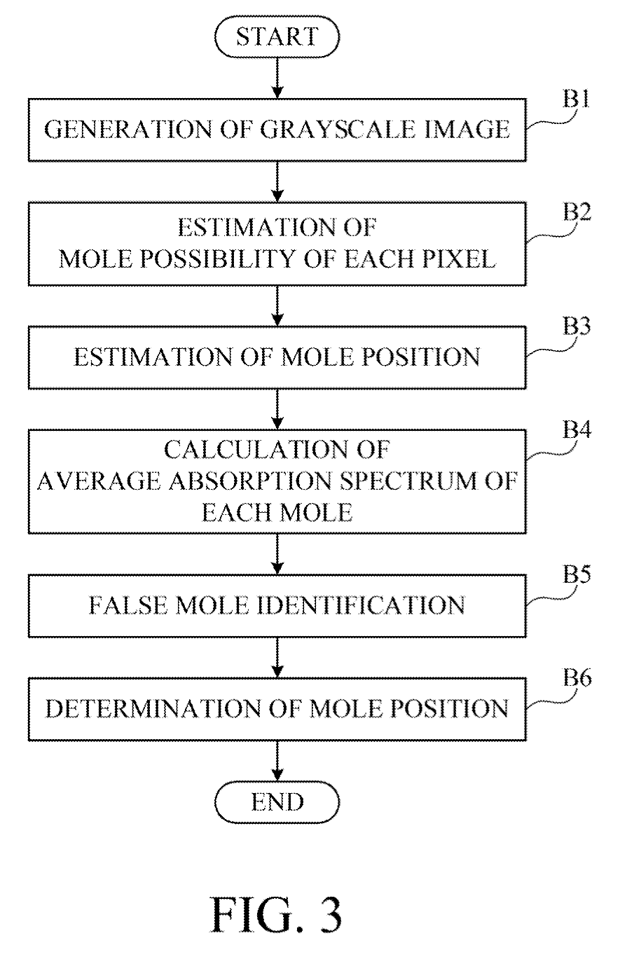

FIG. 3 shows the detailed procedure of the mole position detection in Step A3. The mole position estimation means 12 calculates the average brightness value of each pixel among all spectra and generates a grayscale image (Step B1). In Step B1, the brightness value I (x) at a pixel position x in the grayscale image is obtained by the following formula in which I (x, λ) is the brightness value at the pixel position x in a spectral image of a wavelength λ and Nsp is the number of spectra:

I(x)=(1/Nsp)Σ_{λ}I(x,λ) [Math 1]

The mole position estimation means 12 obtains a mole possibility for each pixel of the grayscale image in order to obtain a possible mole region from the grayscale image generated in Step B1 (Step B2). Here, the mole possibility is defined as a value obtained by dividing the brightness of the center pixel by the lowest value among the brightness values of the surrounding pixels within a radius of three pixels. More specifically, the ratio in brightness r between the center pixel and surrounding pixels that is given by the following formula is defined as the mole possibility:

$$\begin{matrix}[ Math 2 ] & \\ r = \frac{brightness value of the center pixel}{\begin{matrix}lowest brightness value of the \\ pixels within a radius of three pixels\end{matrix}} & ( 1 )\end{matrix}$$

In the above formula 1, the center pixel is excluded for obtaining the lowest brightness value of the surrounding pixels in the denominator.

The mole position estimation means 12 estimates the mole position using the mole possibility of each pixel obtained in Step B2 (Step B3). The mole possibility r defined by the above formula 1 is high when the center pixel has brightness higher than the surrounding pixels and low when the center pixel has brightness lower than the surrounding pixels. In moles; the center pixel tends to have brightness lower than the surrounding pixels. Therefore, a region having a low mole possibility r is considered to be a mole region in Step B3. For example, N pixels having the lower mole possibilities r are selected and considered to form the mole center position.

The mole position estimation means 12 calculates the average absorption spectrum of each mole in the possible mole regions for each wavelength based on each spectral image (Step B4). In Step B4, the average absorption spectrum of a mole for each wavelength is calculated by obtaining the average among the pixels within a radius c from a pixel xᵢ using the following formula in which I (xᵢ, λ) is the brightness value of the center pixel xᵢ of the i-th mole among N moles obtained.

[Math 3]

Iᵢ(λ)=(1/Nᵢ)Σₓ_{ᵢ}_{εΩ}_{ᵢ}I(xᵢλ) (2)

Here, Nᵢ, is the number of pixels within a radius c and Ωᵢ is a set of pixels within the radius c around xᵢ. c is a variable indicating the size of a mole and adjusted to a proper value according to the resolution of the image.

The moles of which the positions are estimated in Step B3 may include false moles in addition to true moles. The mole position estimation means 12 takes advantage of the image composed of multiple spectra and compares the average absorption spectra of different wavelengths to identify false moles (Step B5). More specifically, false moles are identified as follows. Moles are skin regions having a higher melanin pigment concentration and have basically the same absorption spectrum as the skin. Then, it is assumed that Iₘ (λ) and Iₛ (λ) have a specific relation (proportional relation) in which Iₘ (λ) is the absorption spectrum of a mole and Iₛ (λ) is the absorption spectrum of the skin.

Assuming that a mole has a small area for the entire face, the absorption spectrum of the skin is presented by the following formula 3.

[Math 4]

Iₛ(λ)=(1/Nₛ)Σ_{xεΩ}_{ₛ}I(x,λ) (3)

Here, Ωₛ is a set of pixels determined to be a skin region and Nₛ is the number of pixels. The absorption spectrum of a mole is approximated by the following formula 4 using the formula 3 and a proper coefficient a.

[Math 5]

Iₘ(λ)=a×Iₛ(λ) (4)

Then, the degree of similarity between the absorption spectrum of a mole in the formula 4 and the average absorption spectrum of each mole in the formula 2 is obtained. The degree of similarity is defined by the following formula 5.

$$\begin{matrix}[ Math 6 ] & \\ {t}_{i} = \frac{{\sum }_{λ} {I}_{m} ( λ ) \cdot {I}_{i} ( λ )}{\sqrt{\{ {\sum }_{λ} {{I}_{m} ( λ )}^{2} \} \{ {\sum }_{λ} {{I}_{i} ( λ )}^{2} \}}} & ( 5 )\end{matrix}$$

Iₘ(λ) in the formula 5 includes an unknown coefficient a. Inserting the formula 4 into the formula 5, the coefficient a is cancelled in the numerator and denominator and the formula 5 is presented by the following formula 6.

$$\begin{matrix}[ Math 7 ] & \\ {t}_{i} = \frac{{\sum }_{λ} {I}_{s} ( λ ) \cdot {I}_{i} ( λ )}{\sqrt{\{ {\sum }_{λ} {{I}_{s} ( λ )}^{2} \} \{ {\sum }_{λ} {{I}_{i} ( λ )}^{2} \}}} & ( 6 )\end{matrix}$$

The above obtained degree of similarity tᵢ is evaluated with a threshold to determine whether or not the extracted mole is a false mole. More specifically, tᵢ calculated by the formula 6 is compared with a given threshold T. The i-th mole is determined to be a true mole when tᵢ is not lower than the threshold and to be a false mole when tᵢ is lower than the threshold. The mole position estimation means 12 regards as true moles the moles excluding the moles determined to be a false mole among the N moles extracted in Step B3 and detects their positions (Step B6). In Step B6, if the number of moles determined to be a false mole is Nf, the positions of (N-Nf) moles are detected.

Returning to FIG. 2, the image verification means 13 perform verification with images registered in a not-shown database in advance using the mole positions of true moles detected in Step A3 (Step A4). The registered images in a database are images of the same spectra of the multispectral image input in Step A1. For example, the input multispectral image has wavelengths of λ1 and λ2, two spectral images of wavelengths λ1 and λ2 are prepared as the registered images. The identification means 14 identifies the subject based on the verification results in Step A4 (Step A5).

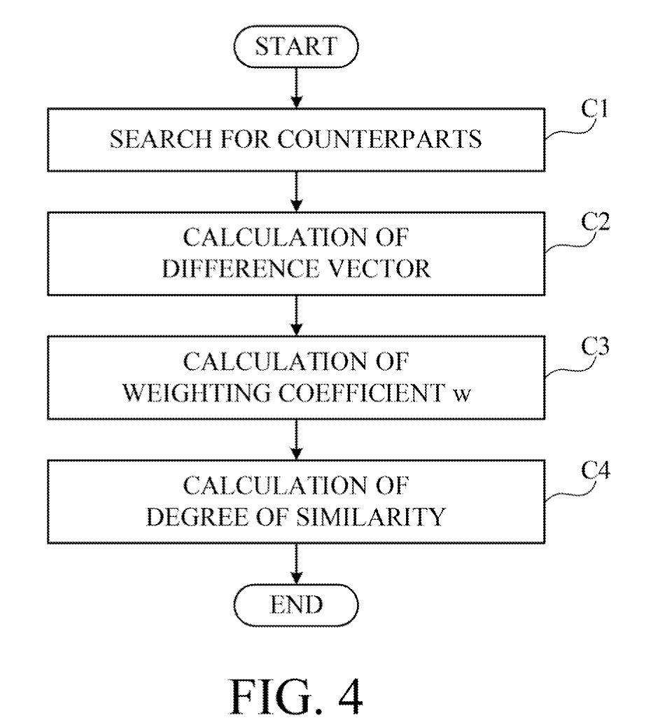

FIG. 4 shows the detailed procedure of the verification in Step A4. Here, face images used for verification are called registered images and verifying images. The registered images are face images registered in a database in association with user identification information. The verifying images are face images input in Step A 1 of FIG. 2. It is assumed that N1 mole positions are obtained from the registered images and N2 mole positions are obtained from the verifying images. The mole positions in the registered images are obtained in the same procedure as in estimating the mole positions from the verifying images shown in FIG. 3. The mole positions in the registered images may be estimated from the registered images upon each verification or registered in a database as mole position data in advance.

The image verification means 13 searches for counterparts between moles in the registered images and moles in the verifying images (Step C1). In search for counterparts; the face position and size in the registered and verifying images are normalized in advance, for example, based on the eye position. It is assumed that N1 mole positions obtained from the registered images are x1 (1), x1 (2), . . . , x1 (N1) and N2 mole positions obtained from the verifying images are x2 (1), x2 (2), . . . , x2 (N2). The coordinates of mole positions are expressed by a two-dimensional vector. In search for counterparts, the distances between the point x1 (i) (i=1, . . . , N1) at the coordinates of mole positions in the registered images and the mole positions in the verifying images are calculated and the nearest mole is considered to be the counterpart.

$${i}^{*} = {argmin}_{j} ‖ x 1 ( i ) - x 2 ( j ) ‖ \qquad [ Math 8 ]$$

Also in the verifying images, the distances between the point x2 (i) (i=1, . . . , N2) at the coordinates of mole positions in the verifying images and the mole positions in the registered images are calculated and the nearest mole is considered to be the counterpart.

$${i}^{*} = {argmin}_{j} ‖ x 2 ( i ) - x 1 ( j ) ‖ \qquad [ Math 9 ]$$

The image verification means 13 obtains a difference vector between the corresponding mole positions after the search for counterparts (Step C2). In the calculation of a difference vector, a difference z1 in mole position of a counterpart in a verifying image from the counterpart in a registered image and a difference z2 in mole position of a counterpart in a registered image from the counterpart in a verifying image are Obtained. The difference vectors z1 and z2 are expressed by the following calculation formula 7.

z1(i)=x1(i)−x2(i*)

z2(i)=x2(i)−x1(i*) (7)

Subsequently, the image verification means 13 calculates a weighting coefficient using the distance between moles (Step C3). The weighting coefficient is a value according to the distance between moles. Desirably, it is a lower value as the distance between moles is larger. The distance between the i-th mole and j-th mole in a registered image is expressed by the following formula.

d_{1,i,j}=∥x1(i)−x1(j)∥ [Math 10]

The weighting coefficient is defined by the following formula using the distance between moles.

w_{1,i,j}=exp(−d_{1,i,j}/d₀) [Math 11]

Also in a verifying image, the weighting coefficient is defined by the following formula using the distance between moles in a verifying image (d₂,i, j).

w_{2,i,j}=exp(−d_{2,i,j}/d₀) [Math 12]

In Step C3, the weighting coefficient is obtained for all combinations of i and j in registered and verifying images.

The image verification means 13 calculates the degree of similarity between mole positions (Step C4). The difference vectors of the counterparts in registered and verifying images are presumably oriented in similar directions if they are of the same person. Then, the following formula 8 is defined as the degree of similarity between mole positions.

$$\begin{matrix}[ Math 13 ] & \\ s = \{ \begin{matrix}{\sum }_{i = 1}^{N 1} {\sum }_{j = 1}^{N 1} {w}_{1 , i , j} \frac{( z 1 ( i ) \cdot z 1 ( j ) )}{‖ z 1 ( i ) ‖ \cdot ‖ z 1 ( j ) ‖} + \\ {\sum }_{i = 1}^{N 2} {\sum }_{j = 1}^{N 2} {w}_{2 , i , j} \frac{( z 2 ( i ) \cdot z 2 ( j ) )}{‖ z 2 ( i ) ‖ \cdot ‖ z 2 ( j ) ‖}\end{matrix} \} / s 0 & ( 8 )\end{matrix}$$

Here, s0 is a normalizing term and expressed by the following formula.

$$s 0 = {\sum }_{i = 1}^{N 1} {\sum }_{j = 1}^{N 1} {w}_{1 , i , j} + {\sum }_{i = 1}^{N 2} {\sum }_{j = 1}^{N 2} {w}_{2 , i , j} \qquad [ Math 14 ]$$

The identification means 14 identifies the subject using the degree of similarity s calculated by the image verification means 13 in Step A5 of FIG. 2. For example, the degree of similarity is compared with a threshold. The subject is identified when it is not lower than the threshold and the subject is determined to be an imposter when it is lower than the threshold.

In this embodiment, the input image is a multispectral image of multiple wavelengths and possible mole regions are extracted from the multispectral image. Then, taking advantage of the input image being a multispectral image, the average spectra of the possible mole regions are compared to distinguish between true moles and false moles. True moles can be distinguished from false moles using the characteristic that true moles have a similar absorption spectrum to the skin region in each spectral image. For authentication, the false moles are excluded and the moles identified as a true mole are used for verification with moles in registered images. Verification without false moles leads to less erroneous verification. Furthermore, any “impersonation” by an ill-intentioned imposter wearing a false mole can be prevented and intrusion of an imposter can be rejected.

The image verification method using moles in the Non-Patent Literature 1 utilizes the degree of similarity based on the positions in an image. Therefore, it is not a sufficiently solid method when the posture is different. In other words, the performance tends to significantly drop unless the same posture is taken for verification in the Non-Patent Literature 1. On the other hand, the Patent Literature 1 simply refers to calculation of the degree of similarity in verification of moles. Any change in the mole position is not taken into account. In this embodiment, the degree of similarity between moles is calculated using geometrically-constraining conditions regarding mole position shifts between images used for verification. Using such a solid verification technique regarding mole position shifts, highly accurate verification is available even if the posture is different between in the registered images and in the verifying images.

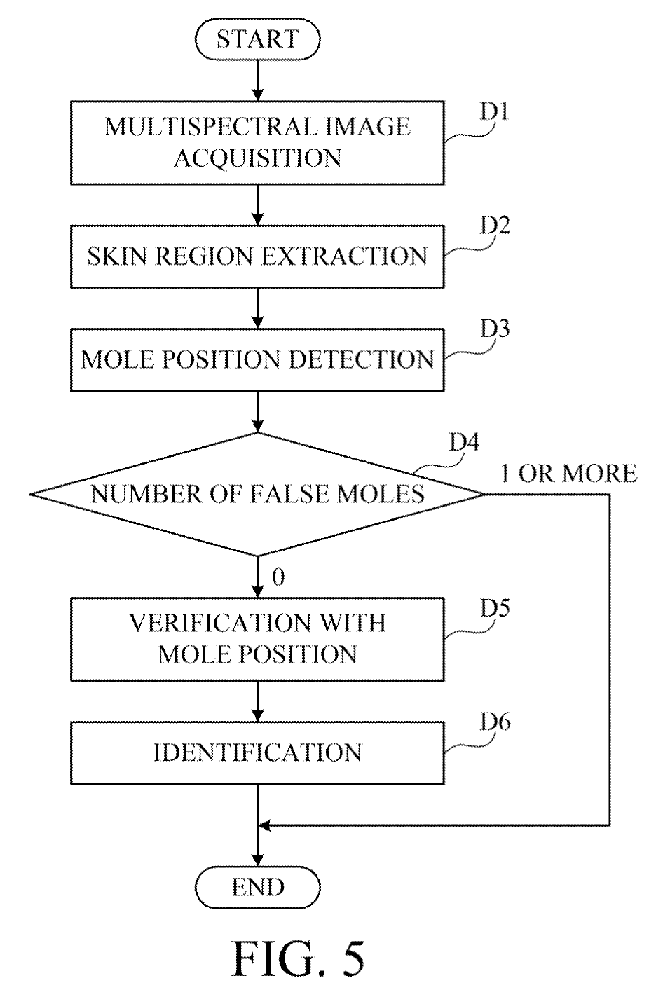

Embodiment 2 of the present invention will be described hereafter. The personal authentication system has the same configuration as in Embodiment 1 shown in FIG. 1. FIG. 5 shows the operation procedure in this embodiment. The image input means 10 inputs a multispectral image (Step D1). The skin region extraction means 11 extracts a skin region from the multispectral image (Step D2). These are the same operations as in Steps A 1 and A2 of FIG. 2. The mole position estimation means 12 detects mole positions and the number of false moles from the extracted skin region (Step D3).

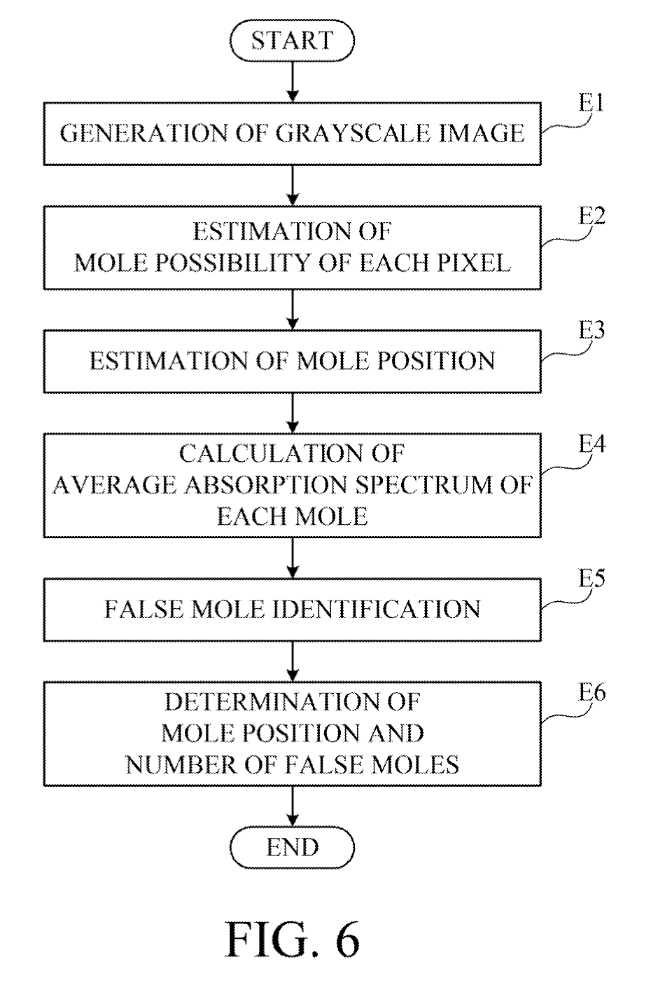

FIG. 6 shows the detained procedure in Step D3. The mole position estimation means 12 generates a grayscale image from the multispectral image (Step E1) and estimates the mole possibility of each pixel (Step E2). Then, the mole position estimation means 12 estimates the mole positions (Step E3), calculates the average absorption spectrum of each mole (Step E4), and identifies false moles (Step E5). The operations in Steps E1 to E5 are the same as those in Steps B1 to B5 of FIG. 3. The mole position estimation means 12 outputs the number Nf of moles determined to be a false mole and the positions of (N−Nf) moles determined to be a true mole (Step E6).

Returning to FIG. 5, the image verification means 13 determines, prior to verification, whether or not it is an imposter based on the number of false moles detected in Step D3 (Step D4). For example, when a given threshold number or more of false moles are detected in the detection of mole positions and number of false moles in Step D3, it is determined to be an ill-intentioned imposter. More specifically, even one false mole is detected; then, it is determined to be an imposter. When it is determined to be an imposter, no verification is performed and the procedure ends.

The image verification means 13 performs verification for identifying the subject using the true moles detected in Step D3 when it is not an imposter (Step D5). The identification means 14 determines whether or not the person in the registered images and the person in the verifying images are the same based on verification results (Step D6). The operations in Steps D5 and D6 are the same as those in Steps A4 and A5.

It is advisable to obtain the number of false moles in an image to be registered and confirm that the number of false moles is zero in the same procedure as in the procedure in FIG. 6 before registering the image in a database. It is advisable to obtain a new image or cancel the registration of the image if the image to be registered has one or more false moles.

This embodiment determines whether or not it is an imposter based on the number of false moles. An imposter is assumed when any false mole is detected and excluded from the verification procedure, whereby the risk of authenticating an ill-intentioned person impersonating someone else is reduced. This embodiment has the same other efficacy as of Embodiment 1.

The present invention is specifically illustrated and described with reference to exemplary embodiments. The present invention is not confined to the above embodiments and their modifications. As apparent to a person of ordinary skill in the field, various modifications can be made to the present invention without departing from the spirit and scope of the present invention set forth in the attached claims.

This application claims the benefit of Japanese Patent Application No. 2008-046463, filed on Feb. 27, 2008, the entire disclosure of which is incorporated by reference herein.

### INDUSTRIAL APPLICABILITY

The present invention has applications in the security field where personal authentication is necessary.

1. A mole identifying method having the following steps:
inputting a multispectral image photographed using an imaging device and composed of a plurality of spectra;
detecting mole candidates from said multispectral image; and
identifying said mole candidates as a true mole or false mole based on the absorption spectra of said detected mole candidates.

2. The mole identifying method according to claim 1 wherein a true mole or false mole is identified based on the absorption spectrum of the skin and the absorption spectra of said moles in said identifying step.

3. The mole identifying method according to claim 2 wherein on the assumption that the absorption spectrum of a true mole is expressed by a function of said absorption spectrum of the skin, the degree of similarity between the absorption spectra of said mole candidates and said absorption spectrum of the skin is obtained and a true mole or false mole is identified according to the obtained degree of similarity in said identifying step.

4. The mole identifying method according to claim 3 wherein said degree of similarity is obtained on the assumption that there is a proportional relation between said absorption spectrum of a true mole and said absorption spectrum of the skin in said identifying step.

5. The mole identifying method according to claim 1 wherein said step of detecting mole candidates has the steps of extracting a skin region from said multispectral image, obtaining the ratio in brightness between the pixels in said extracted skin region and the pixels surrounding these pixels, and detecting mole candidates based on said ratio in brightness.

6. A personal authentication method having the following steps:
inputting a multispectral image photographed using an imaging device and composed of a plurality of spectra;
detecting mole candidates from said multispectral image;
identifying said mole candidates as a true mole or false mole based on the absorption spectra of said detected mole candidates and detecting the positions of said moles identified as a true mole; and
verifying face images based on the positional relationship between said moles identified as a true mole and the moles detected in registered verification images.

7. The personal authentication method according to claim 6 wherein said step of verifying face images has the steps of extracting counterparts between said moles identified as a true mole and moles identified as a true mole in said registered images, calculating the difference vectors from the coordinates of the counterparts, and obtaining the degree of similarity between characteristic points using the difference vectors at the characteristic points being oriented in similar directions.

8. The personal authentication method according to claim 6 wherein it is determined to be an imposter when a given number or more of false moles are detected in said step of identifying true moles and false moles and ended the procedure.

9. A mole identifying device comprising:
an image input unit inputting a multispectral image photographed using an imaging device and composed of a plurality of spectra; and
a mole position estimation unit detecting mole candidates from said multispectral image and identifying said mole candidates as a true mole or false mole based on the absorption spectra of said detected mole candidates.

10. A personal authentication device comprising:
an image input unit inputting a multispectral image photographed using an imaging device and composed of a plurality of spectra;
a mole position estimation unit detecting mole candidates from said multispectral image, identifying said mole candidates as a true mole or false mole based on the absorption spectra of said detected mole candidates, and detecting the positions of the moles identified as a true mole; and
an image verification unit verifying face images based on the positional relationship between said moles identified as a true mole and the moles detected in registered images.

11. A computer-readable recording medium which stores a program allowing a computer to execute procedures for identifying moles contained in a face image wherein said program allows said computer to execute the following procedures:
inputting a multispectral image photographed using an imaging device and composed of a plurality of spectra;
detecting mole candidates from said multispectral image; and
identifying said mole candidates as a true mole or false mole based on the absorption spectra of said detected mole candidates.

12. A computer-readable recording medium which stores a program allowing a computer to execute personal authentication using moles contained in a face image wherein said program allows said computer to execute the following procedures:
inputting a multispectral image photographed using an imaging device and composed of a plurality of spectra;
detecting mole candidates from said multispectral image;
identifying said mole candidates as a true mole or false mole based on the absorption spectra of said detected mole candidate and detecting the positions of the moles identified as a true mole; and
verifying face images based on the positional relationship between said moles identified as a true mole and the moles detected in registered images.
